(19) United States
(12) Patent Application Publication
(10) Pub. No.: US 2011/0145868 A1
(43) Pub. Date: Jun. 16, 2011

(54) Sharing Media in a Communication Network

(75) Inventor: Jan Hultkrantz, Bromma (SE)

(73) Assignee: TELEFONAKTIEBOLAGET LM ERICSSON (PUBL), Stockholm (SE)

(21) Appl. No.: 13/058,511

(22) PCT Filed: Aug. 14, 2008
(86) PCT No.: PCT/EP2008/060678

§ 371 Date: Feb. 10, 2011

(51) Int. Cl. H04N 7/16

(52) U.S. Cl. 725/62

(57) ABSTRACT

A method and apparatus for providing shared media data in a communication network. A Video Content Call Server (VCC-S) receives a request message from a calling party requesting a video content call with a called party. The message includes information identifying the called party, and information identifying the video content. The VCC-S establishes a video content call between the calling party and the VCC-S, and a video content call between the called party and the VCC-S. The same video content is sent at substantially the same time from the VCC-S to both the calling party and the called party.

### TECHNICAL FIELD

The invention relates to the field of sharing media in a communication network.

### BACKGROUND

Sharing media content such as video is becoming popular amongst mobile telephone users. However, there are limited options by which media content can be shared. Consider that case where mobile user A wishes to share video content with mobile user B. One way for this to be done is for user A to forward a web link or mobile content link to user B. User B can use this link to download and view the video content. Another option is for user-generated content from A or B to be made available for each other on a server that both users can access.

However, this type of video sharing is restrictive. User B can access the content, but there is no dynamic interaction between the two users and the content. One way to provide more interaction is to use a video-capable Multiparty Conference Unit (MCU). A conference can be set up between the A user, the B user and streamed video content as a third participant. This involves inviting the streamed video content to the conference via a dial out from the MCU. The streamed content could be reached, for example, via an E.164 number. However, this solution has several limitations and requires an E.164 number to be allocated for the specific video content, which therefore restricts when and how video content can be shared.

### SUMMARY

The inventor has realised that prior art ways of sharing media, especially in mobile networks, allow for limited interaction between two or more users whilst the media is being viewed. According to a first aspect of the invention, there is provided a method of providing shared media data in a communication network. A Video Content Call Server (VCC-S) receives a request message from a calling party requesting a video content call with a called party. The message includes information identifying the called party, and information identifying the video content. The VCC-S establishes a video content call between the calling party and the VCC-S, and a video content call between the called party and the VCC-S. The same video content is sent at substantially the same time from the VCC-S to both the calling party and the called party.

An optional way to set up the video content call is, after receiving the request message at the VCC-S, to send a first video content call invite message from the VCC-S to the calling party and, after establishment of the video content call with the calling party, to send a second video content call invite message from the VCC-S to the called party.

In an alternative option the request message further comprises a request to establish a video content call with the VCC-S, in which case a video content call is established between the calling party and the VCC-S, and a video content call invite message is sent from the VCC-S to the called party to establish a video content call between the called party and the VCC-S;

As an option, the method comprises receiving a command from the calling party relating to controlling a presentation of the video content. This command may be a, for example, a Dual Tone Multifrequency (DMTF) signal. This allows the calling party to control a video presentation that is seen by both the called party and the calling party.

If multi-party video conferencing is required, the method optionally comprises establishing a video content call between the VCC-S and a plurality of parties, wherein at least one of the called or calling party is a Multiparty Conference Unit.

The video content is optionally stored at the VCC-S or obtained from a remote node.

According to a second aspect of the invention, there is provided a VCC-S, which has a first receiver for receiving a request message from a calling party requesting a video content call with a called party. The message includes information identifying the called party and information identifying the video content. A processor is provided for processing the request message and extracting the information identifying the called party and the information identifying the video content. A first transmitter is arranged to transmit signals used in establishing a video content call between the calling party and the VCC-S, and second transmitter is arranged to transmit signals used in establishing a video content call between the called party and the VCC-S. Third and fourth transmitters are provided for sending the same video content from the VCC-S at substantially the same time to both the calling party and the called party.

As an option, the VCC-S comprises a second receiver for receiving from the calling party a command relating to controlling a presentation of the video content. This command optionally comprises an instruction to ignore selected commands received from the calling party, in which case the VCC-S is provided with a fifth transmitter for sending the selected received commands to a Multiparty Conference Unit node (or other DTMF controlled node which has been connected as a B-party to VCC-S) in the communication network.

The VCC-S is optionally provided with a memory in which video content is stored and/or a receiver for receiving video content from a remote node.

According to a third aspect of the invention, there is provided a user device for establishing a video call with a remote user device in a communication network. The user device is provided with an input device usable for selecting a called party and video content, and a processor for generating a request message. The message includes information identifying the called party, and information identifying the video content. A transmitter is provided for sending the request message to a VCC-S, and a receiver is provided for receiving video content from the VCC-S, the received video content also being sent to the called party from the VCC-S at substantially the same time.

The request message optionally includes an invite to establish a video content call with the VCC-S. Alternatively, the user device is provided with a second receiver for receiving from the VCC-S an invite to establish a video content call with the VCC-S.

The user device optionally comprises a second transmitter for sending a command to the VCC-S, the command relating to the presentation of the video content. This command is optionally sent as a DMTF signal.

### BRIEF DESCRIPTION OF THE DRAWINGS

FIG. 1 illustrates schematically in a block diagram a network architecture according to an embodiment of the invention;

FIG. 2 illustrates schematically in a block diagram a network architecture according to an embodiment of the invention in which two users of mobile devices wish t share video content;

FIG. 3 is a signalling diagram illustrating an embodiment of the invention;

FIG. 4 is a signalling diagram illustrating a further embodiment of the invention;

FIG. 5 is a signalling diagram illustrating a third embodiment of the invention;

FIG. 6 is a flow diagram illustrating an embodiment of the invention;

FIG. 7 illustrates schematically in a block diagram a Video Content Call Server according to an embodiment of the invention;

FIG. 8 illustrates schematically in a block diagram a user device according to an embodiment of the invention; and

FIG. 9 is a signalling diagram according to a further embodiment of the invention.

### DETAILED DESCRIPTION

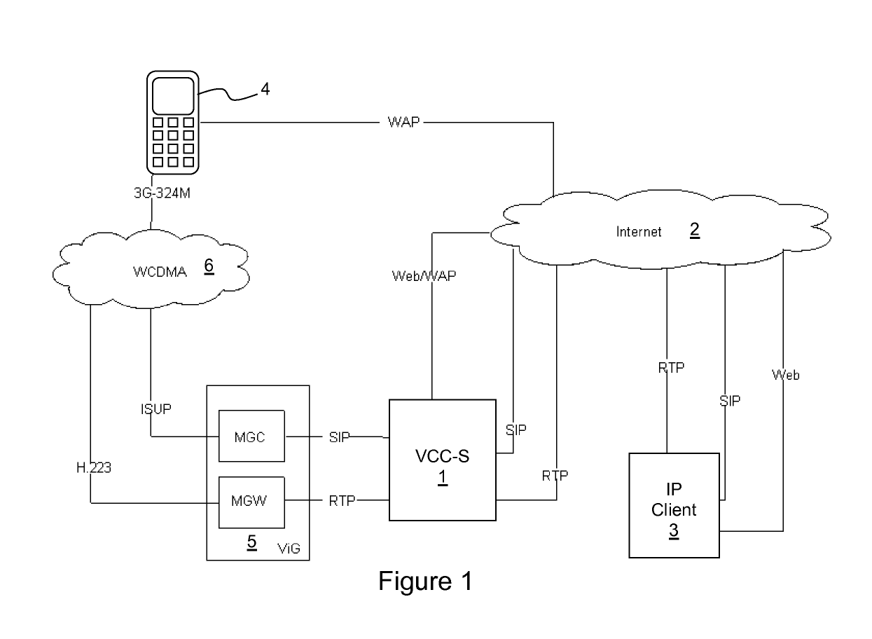

Referring to FIG. 1, there is illustrated a new network node termed herein a Video Content Call Server (VCC-S) 1. The VCC-S1 can connect to an Internet network 2, and thus to an IP client 3 on a device such as a personal computer or mobile telephone. The VCC-S1 can also connect to a mobile telephone 4 via a Gateway node 5 and a telephony network 6 such as a Wideband Code Division Multiple Access (WCDMA) network. The invention allows video sharing between various different terminal nodes, such as between mobile telephones, personal computers, fixed line telephones, PDAs and so on.

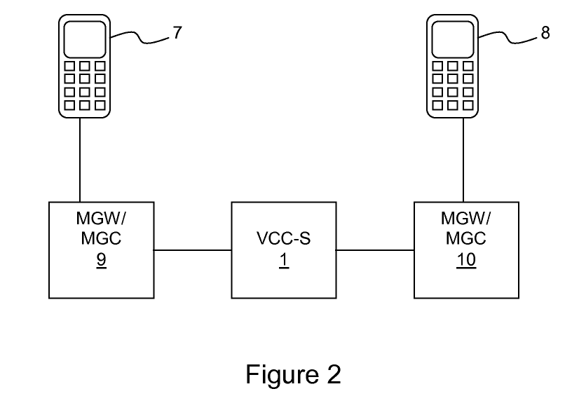

FIG. 2 illustrates the case where mobile user A 7 wishes to share media content with mobile user B 8. The figure has been simplified for clarity. Mobile user A 7 connects to a VCC-S1 via a Media Gateway/Media Gateway Controller 9, and mobile user B 8 connects to the VCC-S via a further Media Gateway/Media Gateway Controller 10. This is shown by way of example only, and it will be appreciated that users having different types of device may be used in place of users A and B having mobile telephones.

User A 7 wishes to share media data such as video content with user B 8. User A 7 selects video content using a Web/WAP interface. A link or URI for each video content is imported into a personal content list handler function in the VCC-S1. When imported to user A's 7 content list in the handler, a number is assigned to the content link. User A 7 may also define a name or alias for the content link. The content list with numbers, corresponding to Dual Tone Multifrequency (DTMF) selection commands, and optionally their names/alias, is then compiled into a Video content call menu to be streamed towards user A7.

The content list can also include links to images (e.g. JPEG, GIF). An image is encoded into a video feed and streamed into the video call in the same way as the video part of a video clip. Furthermore, the content list can also include links to WAP pages or Web pages. A WAP page or a Web page is encoded into a video feed and streamed into the video call in the same way as the video part of a video clip. Similarly, the content list can also include links to live steamed content.

In a further specific embodiment, user A 7 sends a content link via SMS, MMS, e-mail or Instant Message to the VCC-S1. If user A 7 sends an SMS with a content link to VCC-S1, the VCC-S1 confirms that the content has been added to the personal content list by sending an SMS back to user A 7, including the content list number that has been assigned to the new content.

A further option is to allow the personal content list, or part of the personal content list, to be generated automatically. This may be from, for example, a community site where different contents stored by a user are tagged with a number, which in a streamed VCC menu represents the DTMF selection number. Such content lists can be also sorted by origin (e g with sub-menus allocated per origin).

Video content clips may be downloaded to the VCC-S1 and stored, or may be obtained by the VCC-S1 from another media content provider. When needed, the content is adapted/transcoded to enable it to be inserted and streamed into a video call. The VCC-S1 can also be configured to support real-time (or near real-time) adaptation/transcoding.

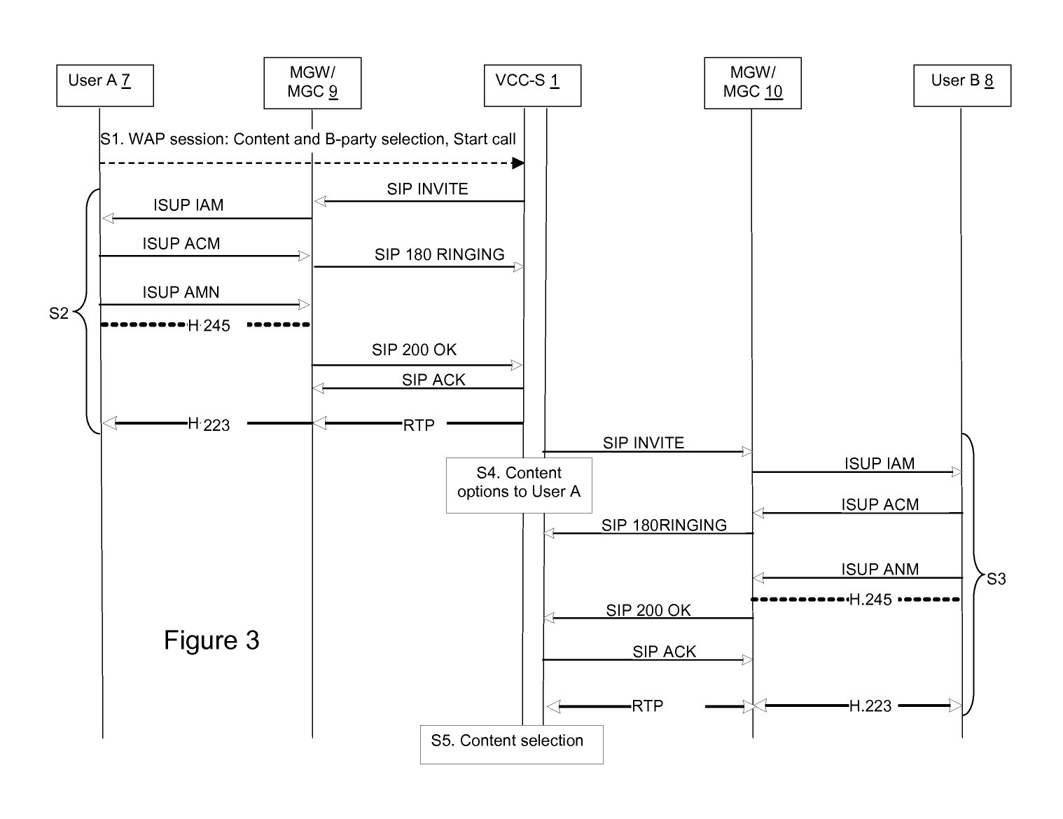

In a specific embodiment of the invention, a video content call can be initiated from the VCC-S towards both user A 7 and user B 8. FIG. 3 illustrates example signalling required for this embodiment. The following numbering corresponds to the numbering in FIG. 3:

S1. User A 7 sends a message via a web or WAP interface to the VCC-S1 including the selected content and an identity or address of user B.
S2. VCC-S1 establishes a video call with User A 7.
S3. Once the video call has been established with user A 7, the VCC-S1 establishes a video call with User B 8 using the same video content.

Note that where DTMF signalling is used, a DTMF menu with A's content options can be send to user A 7 (step S4), and the A party can control content selection using DTMF (step S5).

In more detail, when the VCC-S1 receives the WAP message from User A 7, it retrieves user B's 8 E.164 numbers and initiates a call to user A 7. Whilst the call is being initiated, the VCC-S1 retrieves a URL to a generic VCC menu and a URL to the selected video content (for example a video clip that is already stored at the VCC-S1). The video call is then established between the VCC-S1 and user A 7. The VCC-S1 then initiates and establishes a video call with user B 8.

The VCC-S1 sends a VCC menu in the video channel to user A 7, and bridges the video call channels between user A 7 and user B 8. User A 7 can then send DTMF signals to the VCC-S1 to control the streaming video content. Such signals may include starting the stream, muting the audio content of the stream to allow the two users to talk to each other whilst the video content is playing, pause, rewind or fast forwarding the stream, adjusting screen layout, inserting other media content, and stopping the video stream.

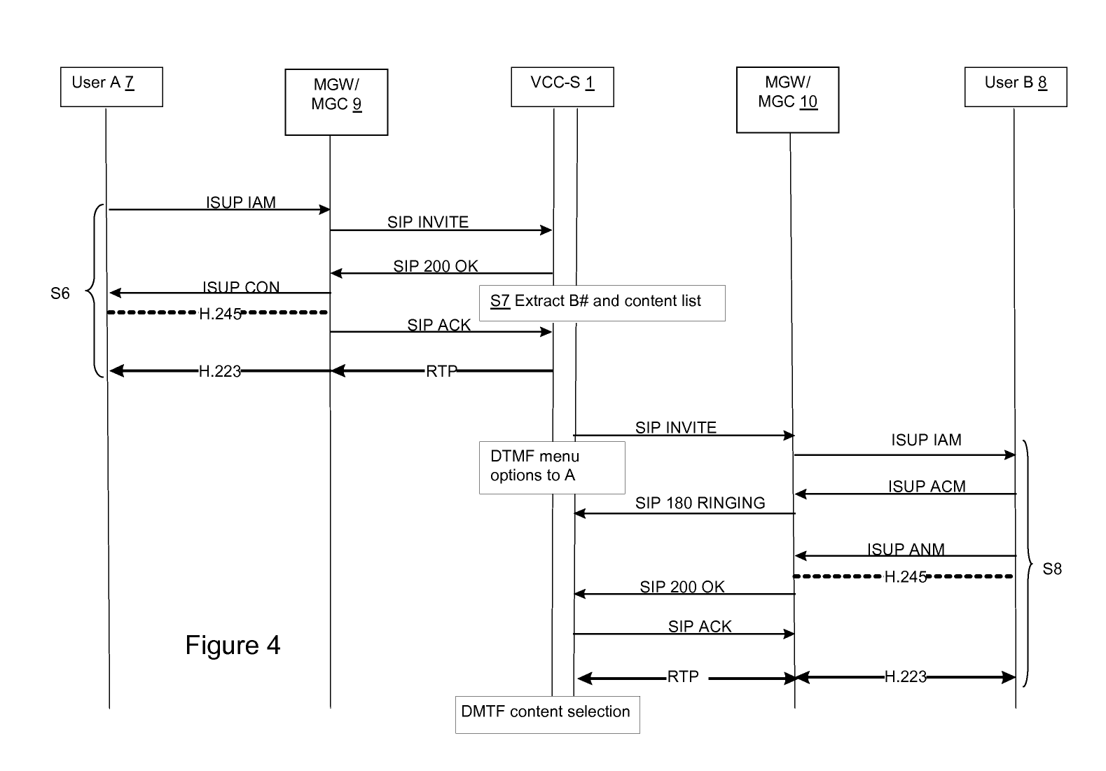

In an alternative embodiment, illustrated in FIG. 4, user A 7 establishes (S6) a video call to the VCC-S1. When the call is received by the VCC-S1, the VCC-S1 uses user A's 7 Calling Line Identity (CLI) to retrieve (S7) a list of contents previously defined by user A 7. User B's 8 number is also extracted from the call-set up/addressing information provided in user A's 7 call (e.g. a prefix is used in front of the user B's number for the Video content call service to route the call to the VCC-S1). When the call has been established between the user A 7 and the VCC-S1, a call from the VCC-S1 to user B 8 is established (S8).

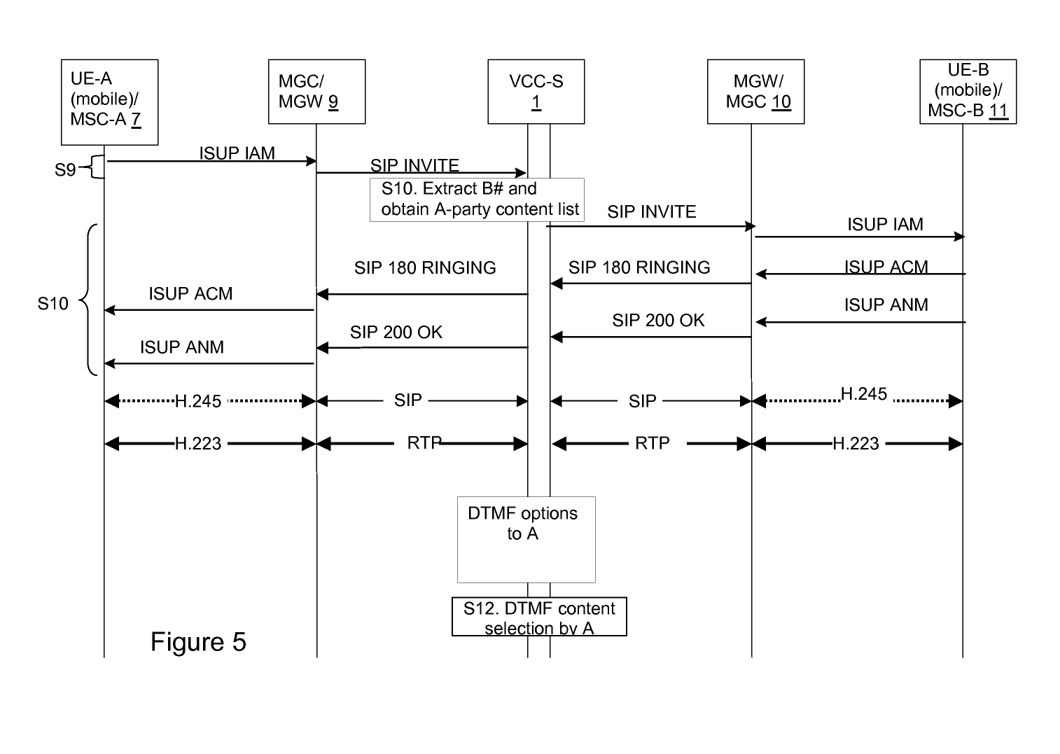

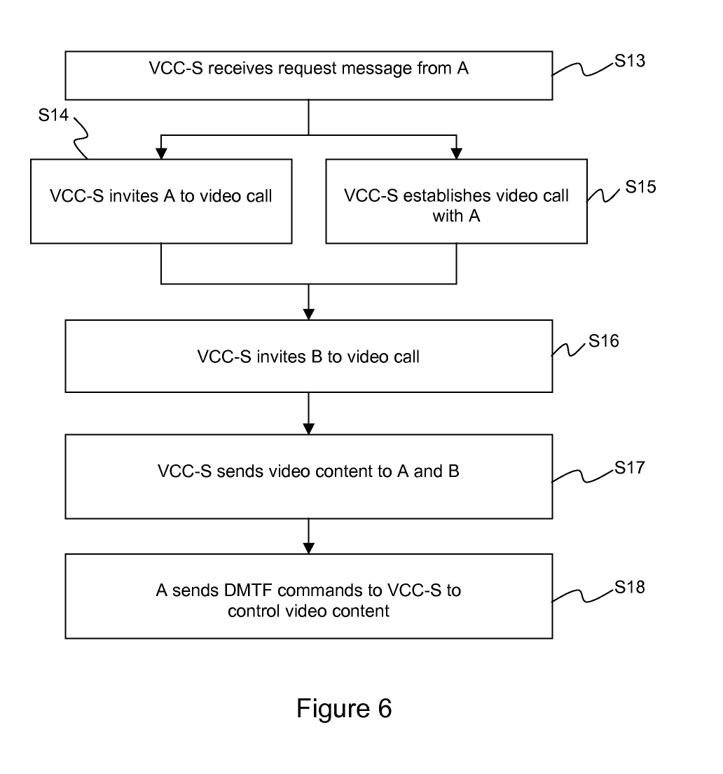

In a third alternative embodiment, illustrated in FIG. 5, user A 7 initiates (S9) a video call which is routed via the VCC-S1. When the call is received by the VCC-S, the VCC-S uses the CLI to retrieve (S10) the list of contents previously defined by user A 7. User B's 8 number is extracted from the call set-up/addressing information from User A 7, for example a prefix may be used in front of User B's number to route the call via the VCC-S1. The call set up signalling is forwarded (S11) between the A party and the B party. When the call has been established, the audio and video channels are connected transparently between the User A 7 and User B 8 resulting in a traditional video call initially. User A can then use DMTF commands (S12) to stream a video content call menu in the video channel from the VCC-S1 to User A 7 and control a video content.

When the call has been established between user A 7 and the VCC-S1, either using the method shown in FIG. 3 or the method shown in FIG. 4, the VCC-S1 streams a Video content menu over a video channel towards user A 7. Where user A 7 controls the video stream using DTMF commands, the menu includes a list of DTMF commands available to user A 7 during the Video content call (e.g. commands to close and retrieve menus, commands for screen-layout options, commands to see user A's personal contents list, commands to start streaming and controlling playback of the content, commands to select links and so on). The menu also includes user A's 7 list of contents, where each content on the list is assigned an individual number. When user A 7 presses a key corresponding to the number for a particular content entry, this content will be streamed from the VCC-S1.

When user B 8 answers, a video call is established between user A 7 and user B 8 via the VCCS 1. The VCCS 1 can be configured to stop the streaming of the menu or content to user A 7 after the video call has been established between the two users.

When a DTMF command is received from user A 7 to start a video content, the VCCS 1 adds the content by streaming it towards both parties via the audio and the video channels between A and B. The VCCS 1 here switches to a n×n (2×1) screen layout format and thereby delivers the video content together with the video from user A/user B side by side. When a video content clip ends, the VCCS 1 switches back to a normal video call by resuming the full screen format for the video between user A 7 and user B 8. The VCCS 1 can, via a DTMF command, display the video content in full screen format towards both parties or display the video content on a larger part of the screen than the video from the remote end. Furthermore, the VCCS 1 can, via a DTMF command, only stream the video part from the video content to both parties and continue to maintain the audio channel as is between A and B. This allows users A and B to discuss over audio whilst both are viewing the video stream. User A 7 can order the VCCS 1 not to start the video content call as a traditional video call, but rather when user B 8 answers the call, a video content can be streamed immediately to both parties while the audio between A and B is sent between the two parties. User A 7 can, via a DTMF command, at any time stop the streaming of a content and start streaming of another content. In addition, user A 7 can use a number of additional DTMF commands during a call as described above.

Participants in a video multiparty conference may place Video content calls into a Multiparty Conference Unit (MCU). In this way these participants can share their video contents among each other by using the mechanisms described above. In some cases, the MCU must be controlled via DTMF commands, for example to control the screen layout from the MCU, etc. For this purpose the VCCS 1 can be ordered, via a DTMF command, to disable its DTMF command functionality. When disabled, the VCCS 1 forwards the DTMF signals transparently to the MCU. The DTMF command functionality in VCCS 1 can be re-enabled via a DTMF command.

The possibility to disable and re-enable the DTMF command functionality at the VCC-S 1 may also be useful in other call cases, such as when a Video content call is forwarded to a video mail box which can be controlled by DTMF commands.

Embodiments of the invention are shown in the flow diagram of FIG. 5, with the following numbering corresponding to FIG. 5:

S13. The VCC-S1 receives a request message from user A 7, which includes information identifying user B 8 and information identifying the required video content.
S14. Where the call-back embodiment is used, the VCC-S1 invites user A 7 to a video call, and the method proceeds at step S12.
S15. Where the request message is an invitation from user A 7 to set up a video call with the VCC-S1, the video call is established between user A 7 and the VCC-S1.
S16. The VCC-S1 invites user B 8 to a video call, and a video call is established between user B 8 and the VCC-S1.
S17. The VCC-S1 sends the same video content previously identified in S9 to both user A 7 and user B 9.
S18. User A can send commands to the VCC-S1 controlling the video content, for example by using DMTF signalling.

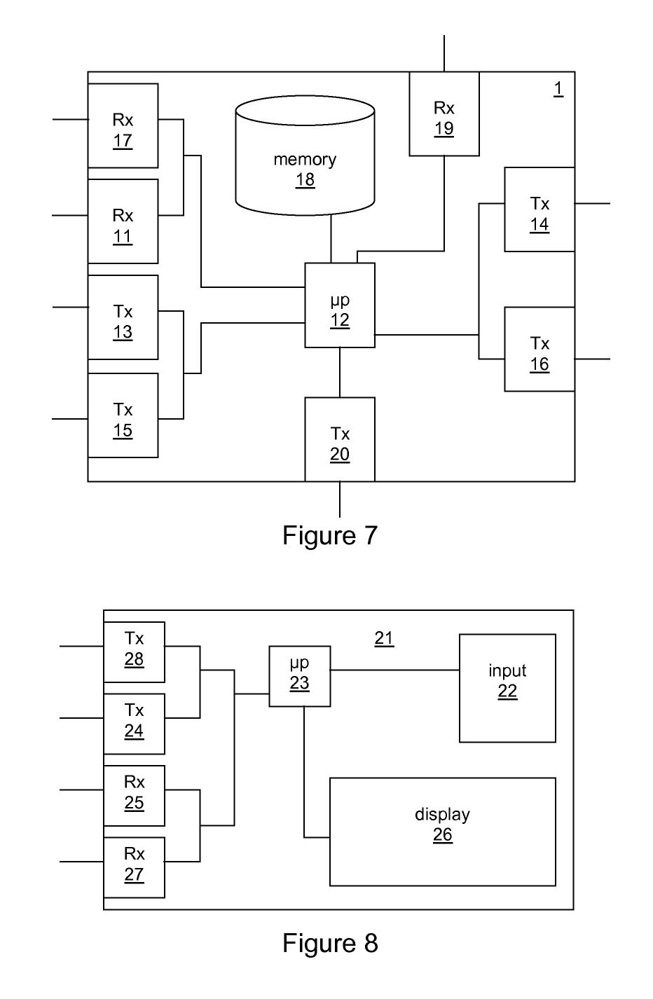

Turning now to FIG. 7, there is shown a VCC-S1 according to an embodiment of the invention. The VCC-S1 is provided with a first receiver 11 for receiving the request from user A 7, which may be an invite to a video call between the VCC-S1 and user A 7 or a request to invite user A 7 to a video call, as described above. A processor 12 is provided for processing the request and extracting an identifier for user B 8 and identifiers for the video content from the request. A first transmitter 13 is provided for communicating with user A 7 to establish the video content call, and a second transmitter 14 is used for establishing a video content call between user B 8 and the VCC-S1. Third and fourth transmitters 15, 16 are also provided for providing video content to user A 7 and user B 8. The VCC-S is provided with a second receiver 17 for receiving command signals as described above from user A 7. The VCC-S may also be provided with a memory 18 for storing video content and other information, and a video content receiver 19 for receiving video content from a remote node. A fifth transmitter 20 may be provided for forwarding DMTF commands to an MCU (or other DTMF controlled node which has been connected as a B-party to the VCC-S), as described above. Of course, whilst various receivers and transmitters are described above as separate functional entities, it will be appreciated that they may be physically embodied in combinations of transmitters, receivers and transceivers.

Optional features of the VCC-S1 include Web and WAP interfaces, SIP signalling interfaces, and RTP interfaces, as well as other standard interfaces depending on the selected set of functionalities and the network environment. These provide capabilities for personal content list handling, such as content list creation, importation of content links, content naming, numbering, folder/menu structure editing etc., and storage of the personal content lists can be made available for Video content calls. Management of generic content lists and generic Video content call menus is provided for, and download and storage of content on a content list can be provided for where applicable. The VCC-S1 may also have capabilities for adaptation of video clip file format and media transcoding for video call compatibility, when applicable. For non-downloaded streamed content: real-time adaptation and media transcoding capabilities may be provided. Provision may be made in the processor 12 for video encoding of images (e g JPEG, GIF) for video call compatibility, and video encoding of WAP and Web pages for video call compatibility, including support for insertion of a cursor with hyperlink detection, cursor jumps between consecutive hyperlinks and hyperlink selection (the VCCS 1 initially scans a downloaded page for hyperlinks, list the positions of hyperlinks and marks one of them).

The processor 12 is also arranged to, at initiation of a Video content call via web/WAP with out-dial to user A 7 and user B 8, support for user A 7 identification (including support for applicable parts of AAA handling) and user B 8 identification or user B 8 address definition. At Video content call initiation via Instant Messaging, the processor may support user A 7 identification (including support for applicable parts of AAA handling) and user B 8 identification or user B 8 address definition. For Video content call via the VCCS 1 dial-in alternative, support is provided for handling of incoming calls from user A 7, including user A 7 content list retrieval, user B 8 identification with either direct call set-up signalling towards user B or call establishment with user A followed by user B 7 dial-out.

The VCC-S1 may also support configuration of a) automatic start of VCC menu streaming towards user A 7 when a video call is established with user A 7 and b) for automatic stop of VCC menu streaming when the video call is established with user B 8. Bridging of audio and video between user A 7 and user B 8 is supported.

A compilation of individual user A 7 content lists into a Video content call menu to be streamed as a video towards user A 7 is supported by the VCC-S1, where for each content, a number, to be selectable via DTMF signals, is included. DTMF signalling from user A 7 to initiate streaming of his/her Video content call menu towards user A 7 is also supported. DTMF signalling from user A 7 to initiate streaming of a selected content towards both user A 7 and user B 8 simultaneously, either as a command during the streaming of the Video content call menu towards user A 7, or as a command to stream the content directly without first going via the menu, can be supported by the VCC-S1.

Other DMTF related support may include the following:
configuring halt of dial-out towards user B 8 (automatic or controlled via DTMF signalling from the user A 7) when the call has been established between user A 7 and the VCCS 1. When halted, a content selected via DTMF will be streamed towards user A 7.
DTMF signalling from user A 7 to initiate dial-out towards user B 8 when previously halted.
DTMF signalling from user A 7 to stream a selected content only towards user A 7 during an ongoing Video content call between A and B (private preview).
DTMF signalling from user A 7 to pause, forward or rewind a streamed video clip.
DTMF signalling from user A 7 to suppress the audio part in a streamed video content.
DTMF signalling from user A 7 to zoom and to move the zoomed centre when the content is a streamed picture or a streamed Web page.
DTMF signalling from user A 7 to move a cursor and to select a hyperlink marked by the cursor when the content is a streamed WAP or Web page. Support to move the zoomed area to follow the cursor when the cursor is moving out from the zoomed area.
insertion of the streamed content into the video call channels, between user A 7 and user AB 8 according to the commands listed above.
mixing the inserted video content with the ongoing media between user A 7 and user B 8 to provide n×n screen-layouts (typically 1×2 format)
enabling user A 7 via DTMF commands, to select and change between the different screen layout options.
when user B's 8 content list is also available in the VCCS 1, support is provided to inform user B 8 about the availability of his/her content list and support is provided for user B 8 to share this content with user A 7 by using the same (applicable set of) DTMF commands as described above.
insertion of user A 7 Calling Line Identity (CLI) at call initiation towards user B 8.
temporarily disabling the DTMF command handler in VCCS 1 and forwarding DTMF commands from user A 7 transparently through the VCCS 1 when disabled.

Turning now to FIG. 8, there is illustrated a user device 21 such as a mobile telephone or a personal computer according to an embodiment of the invention. The user device 21 has an input device 22 that the user can use to select a called party and video content. Examples of such an input include a mouse, a keyboard and a touch screen. A processor 23 is provided for generating the request message including information identifying the called party and information identifying the video content. A first transmitter 24 is provided for sending the request message to the VCC-S1. A receiver 25 for receiving video content from the VCC-S1, which can be rendered on a display 26. A second receiver 27 may be provided an invite to establish a video content call with the VCC-S1. A second transmitter 28 is also provided for sending DTMF commands to the VCC-S, as described above.

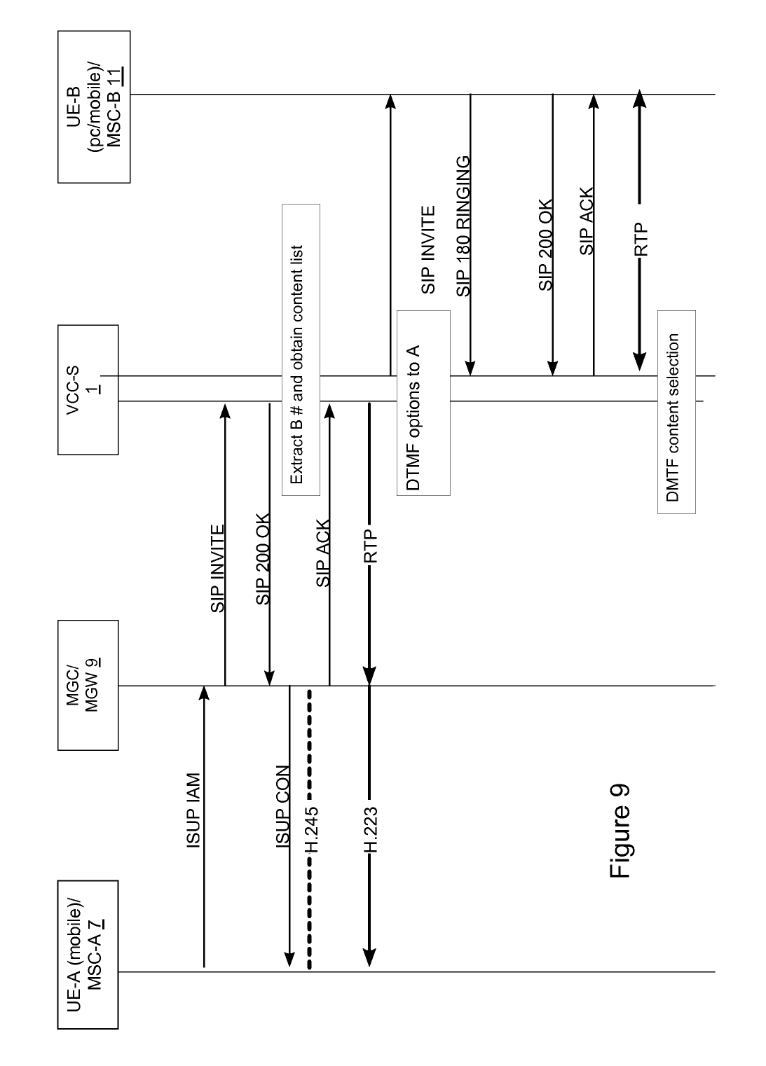

Referring to FIG. 9, a signalling diagram is shown in which user B is using a device such as a personal computer 11. The signalling is substantially the same as that shown in FIG. 4, except that signalling between the VCC-S1 and user B 8 does not traverse a MGC/MGW 11.

The function of the VCC-S1 is primarily intended for call scenarios involving a mobile 3G-324M user and for sharing of video clips. However, the invention is not limited to these call scenarios or to this content type. A user can select content from a network server for sharing with another user. By establishing a communication channel between the users via the VCC-S1, selected content can be sent from the network to both parties over this channel, such that both parties receive the same content presentation, and at the same time can have ongoing conversation. The content can be controlled by DTMF commands, or other types of command, where applicable commands depend on the type of content (e g pause, forward and rewind for video clips or zoom, etc for static content). A video gateway system may be used to perform conversion between PLMN and Internet protocols and, if necessary, transcoding of audio and video codecs to suit the capabilities of the user devices. It will be appreciated by the person of skill in the art that various modifications may be made to the above-described embodiments without departing from the scope of the present invention.

1-16. (canceled)

17. A method implemented by a Video Content Call Server for providing shared media data in a communication network, the method comprising:
receiving a request message from a calling party requesting a video content call with a called party, the request message including information identifying the called party and information identifying video content;
establishing a video content call between the calling party and the Video Content Call Server;
establishing a video content call between the called party and the Video Content Call Server using the information in the request message that identified the called party; and
sending the video content identified in the request message at substantially the same time to both the calling party and the called party via the established video content calls.

18. The method according to claim 17, further comprising:
after receiving the request message, sending a first video content call invite message to the calling party; and
after establishment of the video content call with the calling party, sending a second video content call invite message to the called party.

19. The method according to claim 17, wherein the request message comprises a request to establish a video content call with the Video Content Call Server, and wherein the method further comprises sending a video content call invite message to the called party to establish the video content call between the called party and the Video Content Call Server.

20. The method according to claim 17, further comprising receiving a command from the calling party relating to controlling a presentation of the video content.

21. The method according to claim 20, wherein receiving the command comprises receiving the command as a Dual Tone Multifrequency signal.

22. The method according to claim 20, wherein the command comprises an instruction to ignore selected commands received from the calling party, and wherein the method further comprises sending the selected commands received from the calling party to a Multiparty Conference Unit node in the communication network.

23. The method according to claim 17, further comprising establishing a video content call between the Video Content Call Server and a plurality of parties, wherein at least one of the parties is a Multiparty Conference Unit.

24. The method according to claim 17, further comprising either:
storing the video content identified in the request message at the Video Content Call Server; or
obtaining the video content identified in the request message from a remote node.

25. A Video Content Call Server for use in a communication network, the Video Content Call Server comprising:
a first receiver configured to receive a request message from a calling party requesting a video content call with a called party, the request message including information identifying the called party and information identifying video content;
a processor configured to process the request message and to extract the information identifying the called party and the information identifying the video content;
a first transmitter configured to send signals to establish a video content call between the calling party and the Video Content Call Server;
second transmitter configured to send signals to establish a video content call between the called party and the Video Content Call Server, using the information in the request message that identified the called party; and
a third and fourth transmitter for sending the video content identified in the request message at substantially the same time to both the calling party and the called party via the established video content calls.

26. The Video Content Call Server according to claim 25, wherein the first transmitter is configured to send a first video content call invite message to the calling party after receiving the request message, and wherein the second transmitter is configured to send a second video content call invite message to the called party after establishment of the video content call with the calling party.

27. The Video Content Call Server according to claim 25, wherein the request message comprises a request to establish a video content call with the Video Content Call Server, and wherein the second transmitter is configured to send a video content call invite message to the called party to establish the video content call between the called party and the Video Content Call Server.

28. The Video Content Call Server according to claim 25, further comprising a second receiver configured to receive from the calling party a command relating to controlling a presentation of the video content.

29. The Video Content Call Server according to claim 28, wherein the command comprises an instruction to ignore selected commands received from the calling party, and wherein the Video Content Call Server further comprises a fifth transmitter configured to send the selected commands received from the calling party to a Multiparty Conference Unit node in the communication network.

30. The Video Content Call Server according to claim 25, further comprising at least one of:
a memory configured to store the video content; and
a receiver configured to receive the video content from a remote node.

31. A user device configured to establish a video call with a remote user device in a communication network, the user device comprising:
an input device configured to select a called party and video content;
a processor configured to generate a request message that includes information identifying the called party and information identifying the video content;
a transmitter configured to send the request message to a Video Content Call Server; and
a receiver configured to receive the identified video content from the Video Content Call Server at substantially the same time as the called party receives the video content from the Video Content Call Server.

32. The user device according to claim 31, wherein the processor is configured to generate the request message to include an invite to establish a video content call with the Video Content Call Server.

33. The user device according to claim 31, further comprising a second receiver configured to receive from the Video Content Call Server an invite to establish a video content call with the Video Content Call Server.

34. The user device according to claim 31, further comprising a second transmitter configured to send a command to the Video Content Call Server that relates to the presentation of the video content.

35. The user device according to claim 34, wherein the second transmitter is configured to send the command as a dual tone multifrequency signal.
